(19) United States
(12) Patent Application Publication
(10) Pub. No.: US 2026/0326851 A1
(43) Pub. Date: Oct. 22, 2026

(54) A VEHICLE SIDECAR

(71) Applicant: SWINGING SIDECARS PTY LTD, Brisbane, Queensland (AU)

(72) Inventors: Peter Cyrus RIZZO, IV, Brisbane (AU); Leo YIP, Brisbane (AU)

(21) Appl. No.: 19/162,768

(22) PCT Filed: Mar. 6, 2024
(86) PCT No.: PCT/AU2024/050181

§ 371 Date: Sep. 5, 2025

(30) Foreign Application Priority Data
Mar. 7, 2023 (AU) 2023900611

(51) Int. Cl. B62K 27/08; B62K 27/10

(52) U.S. Cl. CPC B62K 27/08; B62K 27/10

(57) ABSTRACT

The invention resides in a vehicle sidecar having a chassis which has a sleeve. The vehicle sidecar also has a suspension device moveably mounted to the sleeve. The sidecar further includes a locking mechanism disposed between the chassis and the suspension device. The locking mechanism is moveable between a release position, whereby the suspension device is adapted to move relative to the sleeve, and a locked position to prevent movement of the suspension device relative to the sleeve.

### FIELD OF THE INVENTION

This invention is concerned with a sidecar for a vehicle. The invention is concerned particularly, although not exclusively, with a sidecar adapted to be connected to a motorbike.

### BACKGROUND OF THE INVENTION

Motorbike sidecars are well known and have been in use for decades, providing a convenient and versatile mode of transportation. Whilst they can be retrofitted to a motorbike the motorbike is often then referred to as a sidecar motorcycle. A sidecar motorcycle is a three wheeled vehicle with the side wheel not directly aligned with the rear motorcycle wheel. The sidecar motorcycle is powered only by the rear wheel of the motorcycle. As such, sidecar motorcycles are different to motor tricycles where both rear wheels are powered and share a common axle.

Traditional motorbike sidecars had several shortcomings, including stability issues, limited manoeuvrability and inadequate safety features.

Very early sidecars were designed to be rigidly fixed to the motorcycle. However, this created handling and safety problems when turning. It is known in the art to secure a sidecar to the motorcycle in a non-rigid manner to allow the side car to lean with the motorcycle into turns.

Regardless, a motorcycle fitted with a sidecar handles very differently to one without a sidecar fitted because a sidecar makes the motorcycle asymmetrical. A fixed sidecar mounted on the right of a motorcycle can go faster in left hand turns because the sidecar prevents the rig from tipping over. In right hand turns, the rig is prone to tip due to the weight imbalance. Driver and sidecar passenger body position affects speed handling, especially on dirt or uneven surfaces. If the sidecar and bike geometry are not coordinated the rig will be unstable, especially at speed, and may shimmy upon acceleration and deceleration which is a significant safety and manoeuvrability concern.

Other recent advances in technology have led to the development of new and improved motorbike sidecars, incorporating features such as improved suspension systems, advanced braking systems, and ergonomic passenger compartments. These improvements have increased the safety and comfort of motorbike sidecars, making them a more attractive option for riders and passengers alike.

Despite these advancements, there remains room for further improvement in the design and functionality of motorbike sidecars. In particular, there is a need for sidecars that offer greater stability, enhanced manoeuvrability, and improved passenger safety features.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### OBJECT OF THE INVENTION

It is an object of the invention to overcome or at least alleviate one or more of the above problems and/or provide the consumer with a useful or commercial choice.

Other preferred objects of the present invention will become apparent from the following description.

### SUMMARY OF THE INVENTION

In one form, although it need not be the only or indeed the broadest form, the invention resides in a vehicle sidecar comprising:
a chassis having a sleeve;
a suspension device moveably mounted to the sleeve; and
a locking mechanism disposed between the chassis and the suspension device;
wherein the locking mechanism is moveable between a release position, whereby the suspension device is adapted to move relative to the sleeve, and a locked position to prevent movement of the suspension device relative to the sleeve.

Preferably, the suspension device is adapted to move longitudinally of the sleeve when the locking mechanism is in a release position.

Suitably, the suspension device is adapted to move rotationally of the sleeve when the locking device is in the release position.

In a preferred form, the chassis further comprises a longitudinal shaft and the sleeve is adapted to be movably mounted on longitudinal shaft when the vehicle sidecar is in use.

Suitably, the sleeve is adapted to be rotatbly mounted on the longitudinal shaft when the vehicle sidecar is in use. Preferably, the sleeve is adapted to be moveably mounted on chassis so as to permit longitudinal movement of the sleeve with respect to the longitudinal shaft when the vehicle sidecar is in use.

Suitably, the locking mechanism is disposed between the sleeve of the chassis and the suspension device.

Preferably, the locking mechanism provides frictional engagement on an outer face of the sleeve of the chassis and the inner face of a sleeve attachment member of the suspension device when the locking mechanism is in the locked position to thereby prevent relative movement of the sleeve of the chassis with respect to the sleeve attachment member of the suspension device.

Further features of the invention will be apparent from the following description of certain embodiments of the invention.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, wherein:

FIG. 1 shows a perspective view of a vehicle sidecar according to an embodiment of the invention releasably secured toa motorbike;

FIG. 2 shows a plan view of the vehicle side car shown in FIG. 1 attached to the motorbike;

FIG. 3 shows a perspective view of certain components of the vehicle sidecar shown in FIG. 1 attached to the motorbike;

FIG. 4 shows perspective view of components of the vehicle sidecar shown in FIG. 1;

FIG. 5 shows a further perspective view of components of the vehicle sidecar shown in FIG. 1;

FIG. 5A shows a partial sectional view of a components of the vehicle sidecar shown in FIG. 1;

FIG. 6 shows a further perspective view of components of the vehicle sidecar shown in FIG. 1;

FIG. 7 shows a further perspective view of components of the vehicle sidecar shown in FIG. 1;

FIG. 8 shows a plan view of components of the vehicle sidecar shown in FIG. 1 attached to the motorbike;

FIG. 9 shows a sidecar passenger compartment in a closed position according to a further embodiment of the invention; and

FIG. 10 shows the sidecar passenger compartment shown in FIG. 9 whilst in the open position.

### DETAILED DESCRIPTION OF THE DRAWINGS

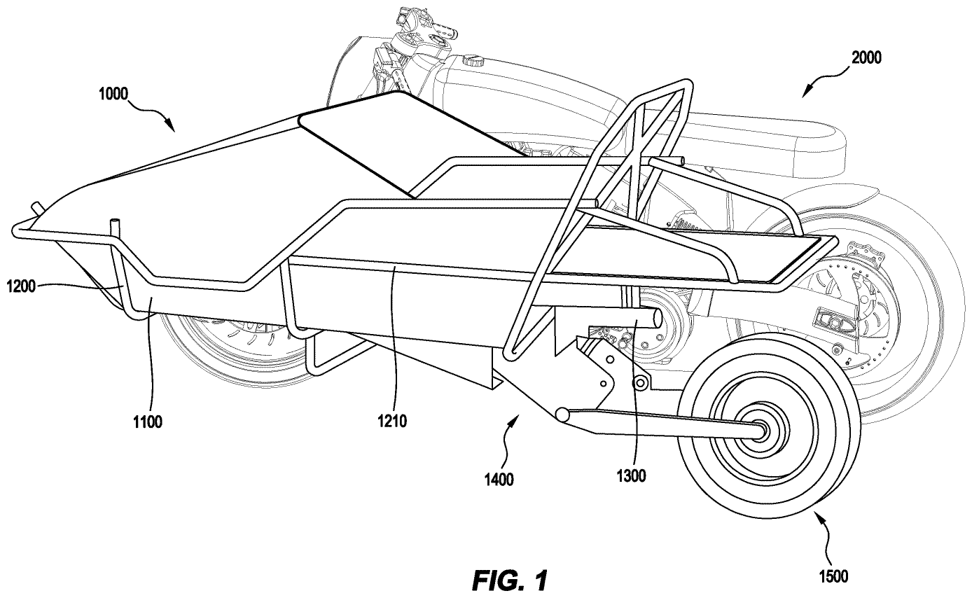

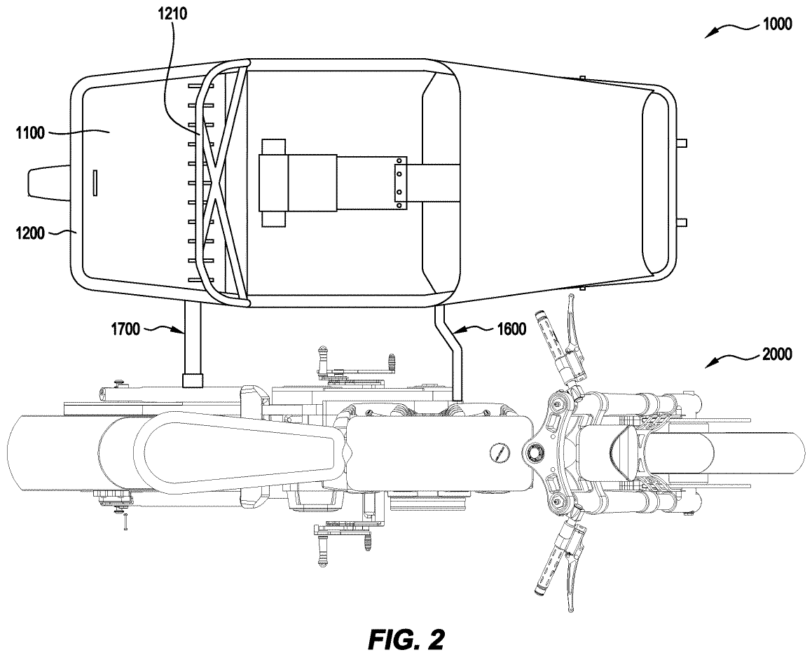

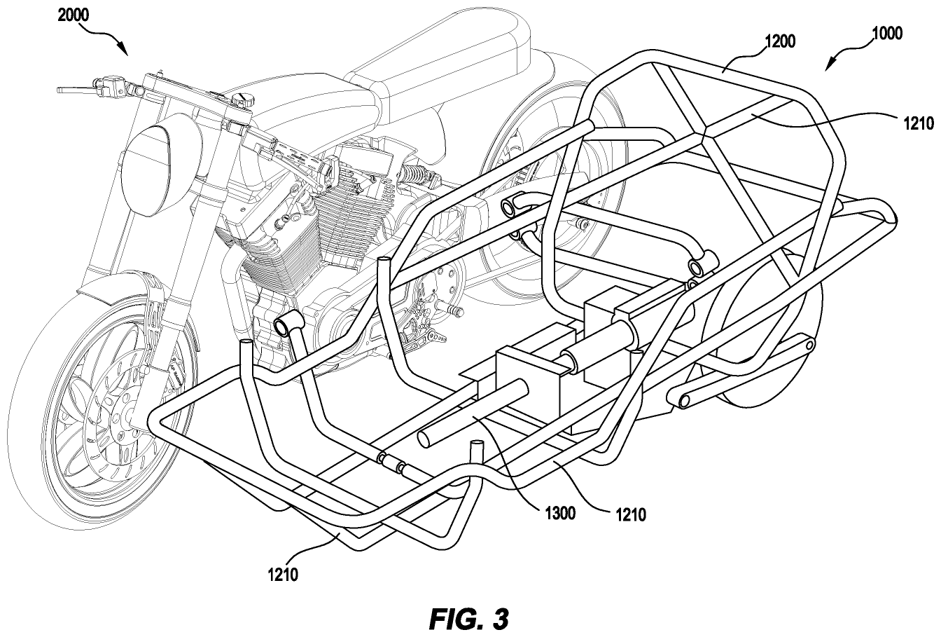

FIG. 1 shows a perspective view of a vehicle sidecar 1000 according to an embodiment of the invention releasably secured to a motorbike 2000, FIG. 2 shows a plan view of the vehicle sidecar 1000 attached to the motorbike and FIG. 3 shows a perspective view of certain components vehicle sidecar 1000 as discussed in greater detail below.

Whilst the embodiment of the invention has been described with reference to a vehicle sidecar 1000 releasably secured to a vehicle in the form of motorbike 2000, it will be appreciated that the vehicle sidecar 1000 may also be adapted to be releasably secured to other vehicles.

Sidecar 1000 is formed from a passenger compartment 1100, a frame 1200, a chassis 1300, a suspension device 1400 moveably mounted to the chassis 1300 and a wheel 1500 rotatably mounted to the suspension device 1400 as discussed in greater detail below. Sidecar 1000 also has a forward vehicle attachment mechanism 1600 and a rear vehicle attachment member 1700 to releasably secure sidecar 1000 to the motorbike 2000.

In the embodiment, the frame 1200 is formed from a series of interlinking struts 1210 as shown so as to provide structure and support for the sidecar 1000. The passenger compartment 1100 is securely fixed to the frame 1200 and is adapted to securely and safely locate a passenger therein.

The passenger compartment 1100 has been removed from the image of the sidecar 1000 shown in FIG. 3 for clarity reasons. In the embodiment, the passenger compartment 1100 is not designed to be removed from the frame 1200 in use.

The chassis 1300 is rigidly attached to the frame 1200 as shown in the embodiment. Suitably, the chassis 1300 is rigidly attached to the frame by way of welding or by a mechanical means such as by way of bolts or the like. The structure and function of the chassis 1300 will be described in greater detail below. The suspension device 1400 is moveably mounted to the chassis 1300 and a wheel 1400 is rotatably mounted to the suspension device 1400 as described in greater detail below.

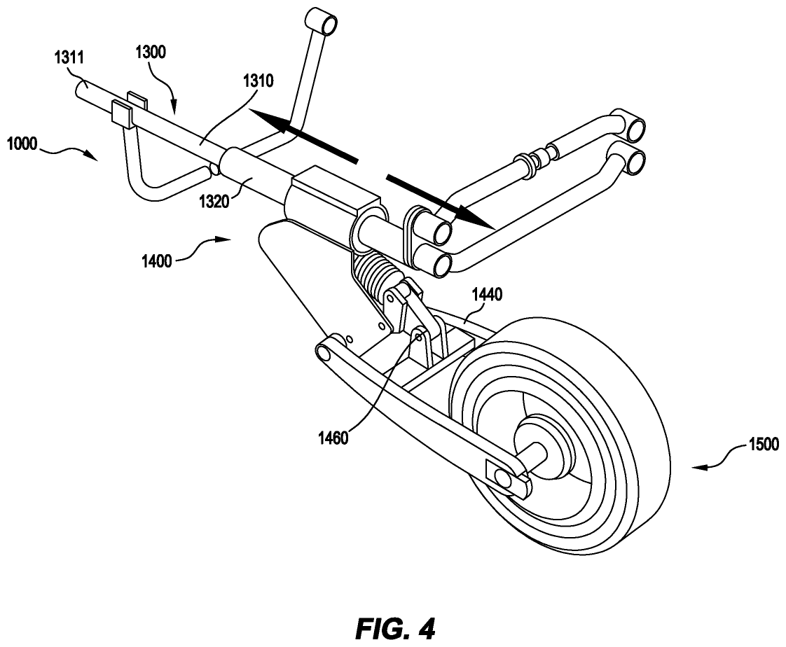

FIG. 4 and FIG5 show a perspective view of the sidecar 1000 with the frame 1200 and passenger compartment 1100 removed from the figure so as to more clearly show aspects of the remaining features of the sidecar 1000.

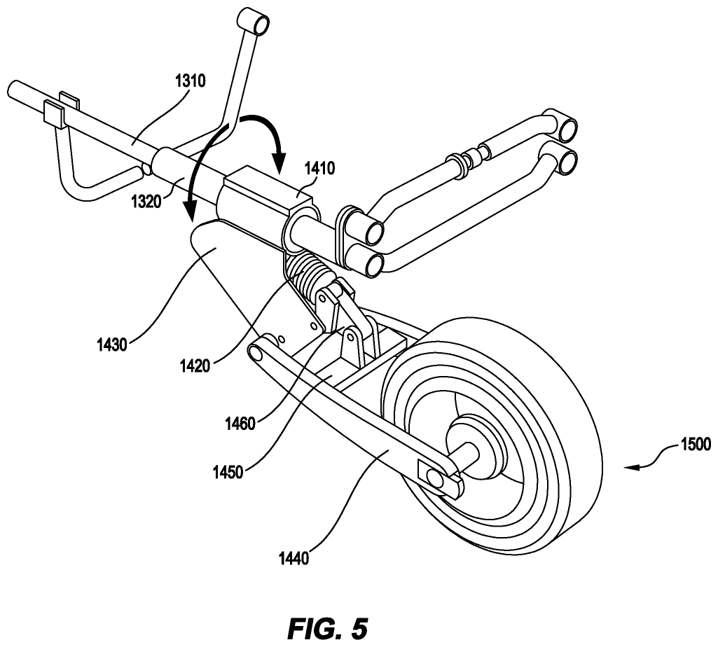

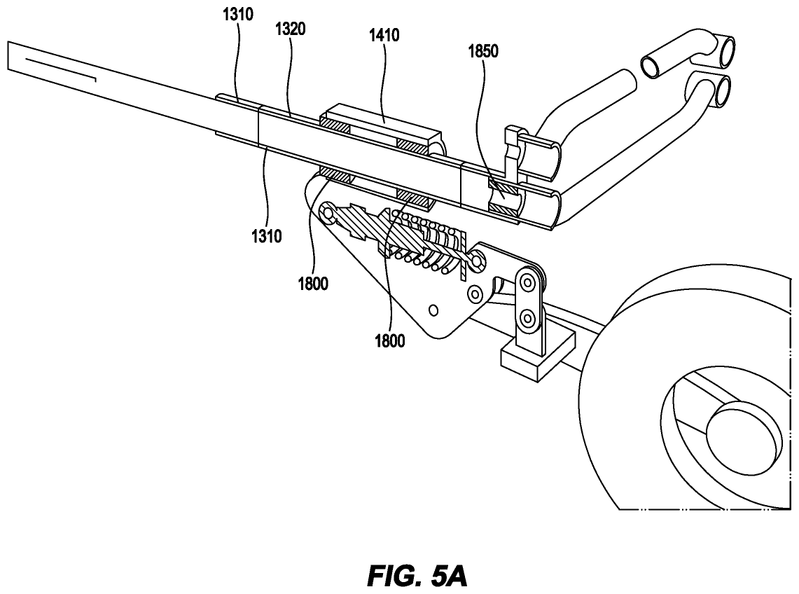

Chassis 1300 is formed from a longitudinal shaft 1310 and a sleeve 1320 moveably mounted on longitudinal shaft 1310. In some embodiments, sleeve 1320 is both slidably mounted on shaft 1310 (so as to facilitate relevant longitudinal movement of the sleeve 1320 with respect to the shaft 1310 as indicated by the arrows in FIG. 4) and also rotatbly mounted on shaft 1310 (so as to facilitate angular movement of sleeve 1320 with respect to shaft 1310 as indicated by the arrows in FIG. 5) when vehicle sidecar is in use.

In the embodiment shown, sleeve 1320 is only able to rotate with respect to longitudinal shaft 1310 and not move longitudinally of shaft 1310 when the vehicle sidecar is in use.

Sleeve 1320 is able to freely rotate with respect to longitudinal shaft 1310 in use so as to accommodate for changes in the direction of the motorbike 2000 having the sidecar 1000 releasably secured thereto.

As previously discussed, a skilled addressee will appreciate that other embodiments within the invention provide for a sleeve 1320 which provides for only one of slidably mounted attachment with respect to the shaft 1310 or rotatbly mounted attachment with respect to the shaft 1310 but not both.

Shaft 1310 also has a series of attachment apertures 1311 located at a forward end of the shaft 1310 with the series extending longitudinally thereof. Attachment apertures 1311 are adapted to securely attach forward vehicle attachment mechanism 1600 as will be described in greater detail below.

FIG. 5A shows a partial sectional view of a suspension device 1400 releasably secured to sleeve 1320 by way of a locking mechanism 1800 disposed therebetween.

Suspension device 1400 has a sleeve attachment member 1410 moveably secured to sleeve 1320 by way of a locking mechanism 1800 disposed therebetween. The locking mechanism 1800 is operable to move between a release position, whereby the sleeve attachment member 1410 is free to move longitudinally along the sleeve 1320 and is also free to rotate with respect to the sleeve 1320, and a locked position which prevents any movement of the sleeve attachment member 1410 with respect to the sleeve 1320.

As such, in the embodiment shown suspension device 1400 is moveable with sleeve 1320 with respect to shaft 1310 of chassis when locking device 1800 is in the locked position so as to enable suspension device 1400 to move with sleeve 1320 in use both longitudinally with respect to shaft 1310 and also rotationally with respect to shaft 1310.

As seen most clearly in FIG. 5A, locking mechanism is 1800 is located on an inner face of sleeve attachment member 1410 and is adapted to contact an outer face of sleeve 1320. In the embodiment, there are two locking mechanisms 1800 so located.

In the embodiment shown, locking mechanisms 1800 are in the form of well known taper locks as is known generally in the mechanical arts. These products are also referred to thrust cones and have a taper face that develops a frictional pressure between the outer face of the sleeve 1320 and an inner face of the sleeve attachment member 1410. That frictional pressure can be varied through adjustment to thereby move the locking mechanism 1800 between the release position, whereby the sleeve attachment member 1410 is free to move longitudinally along the sleeve 1320 and is also free to rotate with respect to the sleeve 1320, and a locked position which prevents any movement of the sleeve attachment member 1410 with respect to the sleeve 1320.

As such, the locking mechanism is 1800 is disposed between the longitudinal shaft 1310 of chassis 1300 and the suspension device 1400. In the embodiment disclosed, the locking mechanism 1800 is disposed between the sleeve attachment member 1410 of the suspension device 1400 and the sleeve 1320 of the chassis 1300 and, in the locked position, is adapted to provide frictional engagement on an inner face of the sleeve attachment device 1410 and the outer face of the sleeve 1320 to prevent relative movement between the sleeve 1320 and the attachment member 1410.

Also, shown in FIG. 5A are bushings 1850 located between the shaft 1310 and the sleeve 1320 to thereby allow rotational movement between the sleeve 1320 and the shaft 1310 in use. It will be appreciated that when the locking mechanism 1800 is in the locked position, the sleeve attachment member 1410 is prevented from moving relative to the sleeve 1320 and, as such in the locked position, the suspension device 1400 then rotates with respect to the shaft 1310 as the sleeve 1320 rotates.

A biasing member in the form of a spring 1420 is mounted to a lower surface of sleeve attachment member 1410 as shown. In the embodiment, a pair of support members 1430 extend from a lower surface of sleeve attachment member 1410 on either side of spring 1420 as shown. Support members 1430 act to shield spring 1420 from damage.

A longitudinal strut 1440 is rotatably attached to a lower end of each support member 1430 distal sleeve attachment member 1410. Each longitudinal strut 1440 extends rearwardly of the respective support member 1430. A lateral strut 1450 extends between the longitudinal struts 1440 as shown. Spring 1420 is rotatably attached to the lateral strut 1450 by way of attachment member 1460 as shown. Wheel 1500 is rotatbly mounted to suspension device 1400 and is mounted between longitudinal struts 1450 as shown.

Suspension device 1400 functions to smooth the passage of the sidecar 1000 as the spring 1420 and the rotatable attachment of the various component parts help dampen bumps in transit.

Forward vehicle attachment device 1600 is selectively secured to a forward end of shaft 1310 and extends to and is secured to motorbike 2000 and rear vehicle attachment device 1700 is a secured to a rear end of shaft 1310 and extends to and is secured to motorbike 200 as shown. The component parts of forward vehicle attachment device 1600 and rear vehicle attachment device 1700 are discussed in greater detail below.

Given that the suspension device 1400 and the wheel are operatively attached to sleeve 1320 of chassis 1300, this enables the suspension device 1400 and the wheel to move relative to the shaft 1310 with the sleeve 1320 whilst in use. In other words, the suspension device 1400 and the wheel are thus mounted on shaft 1310 (so as to facilitate relevant longitudinal movement of the suspension device 1400 and the wheel 1500 with respect to the shaft 1310 as indicated by the arrows in FIG. 4) and also rotatbly mounted on shaft 1310 (so as to facilitate angular movement of suspension device 1400 and the wheel 1500 with respect to shaft 1310 as indicated by the arrows in FIG. 5) Furthermore, the angle that the wheel 1500 makes with reference to the ground relative to the angle that the motorbike 2000 wheels make with reference to the ground is able to be selectively varied and locked in place by way of the locking mechanism 1800 preventing any relative movement between the sleeve 1310 and the sleeve attachment device 1410 when in the locked position. Furthermore, the longitudinal location of the sidecar wheel 1500 relative to the rear wheel of the motorbike 2000 can also be selected and locked in place by way of the locking mechanism preventing any relative movement between the sleeve 1310 and the sleeve attachment device 1410 when in the locked position.

This ability to vary these relative parameters advantageously allows the stability, manoeuvrability, and passenger safety characteristics of the sidecar 1000 to be fine-tuned to allow for variation to suit individual preferences and different road conditions. It also provides for flexibility in setting up the sidecar 1000 to optimise the stability, manoeuvrability, and passenger safety characteristics of the sidecar 1000 regardless of the make or model of motorbike to which it is secured.

FIG. 4 and FIG. 5 show a perspective view of the sidecar 1000 with the frame 1200 and passenger compartment 1100 removed from the figure so as to more clearly show aspects of the remaining features of the sidecar 1000.

As previously mentioned, forward vehicle attachment device 1600 is selectively secured to a forward end of shaft 1310 and extends to and is secured to motorbike 2000 and rear vehicle attachment device 1700 is a secured to a rear end of shaft 1310 and extends to and is secured to motorbike 200.

Forward vehicle attachment device 1600 is formed from a first member 1610, a second member 1620 and a spacer member 1630 releasably secured between first member 1610 and second member 1620 as shown.

First member 1610 has an attachment clamp 1640 located at an end of first member 1610 distal the end releasably secured to spacer member 1630. Attachment clamp 1640 is configured to be releasably secured to shaft 1310 of chassis 1300 as discussed in greater detail below.

Second member 1620 has an attachment mechanism 1650 located at an end of second member 1620 distal the end releasably secured to spacer member 1630. Attachment mechanism 1650 is configured to be secured to a forward portion of motorbike 2000. In the embodiment, attachment mechanism is configured to be secured to the crash bar of motorbike 2000.

In the embodiment, first member 1610 and second member 1620 are shaped such that they each have an elbow which provides that releasable securement of each to spacer member 1630 occurs closer to the ground than the level of the shaft 1310 of the chassis 1300.

Rear vehicle attachment device 1700 is formed from an upper member 1710 extending from a rear end of shaft 1310 of chassis 1300 to a rear end of motorbike 2000 and a lower member 1720 extending from a rear end of shaft 1310 of chassis 1300 to a rear end of motorbike 2000.

Both upper member 1710 and lower member 1720 are securely fastened at one end to chassis 1300 and operatively secured to motorbike 2000 at the opposing end. In the embodiment, upper member 1710 and lower member 1720 are operatively secured to the pegs of the motorbike 2000.

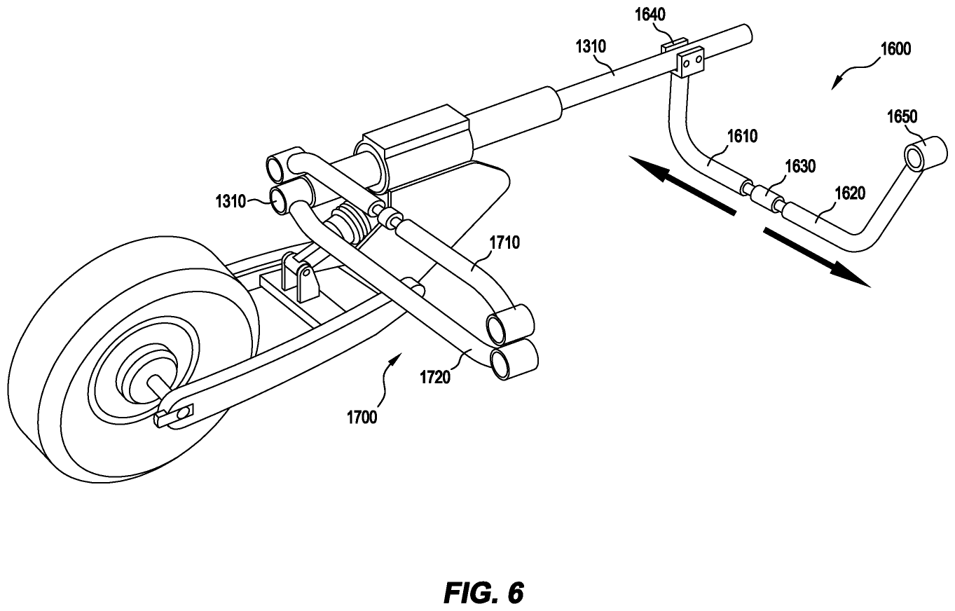

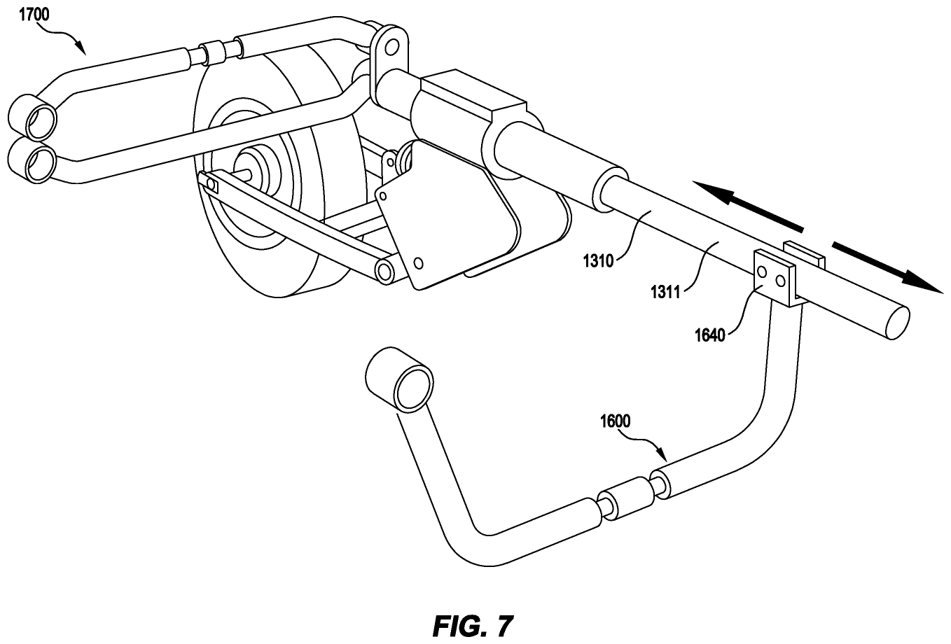

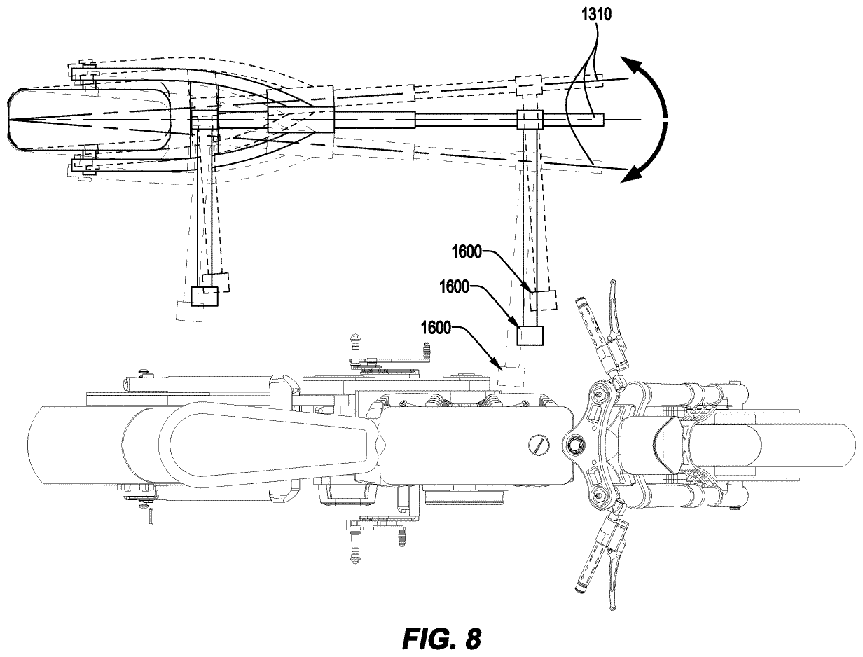

FIGS. 6 and 7 show perspective views of the sidecar 1000 attached to the motorbike 2000 with the frame 1200 and passenger compartment 1100 removed from the figures so as to more clearly show aspects of the remaining features of the sidecar 1000. FIG. 8 shows a plan view of the sidecar 1000 in three separate positions attached to the motorbike 2000. Forward vehicle attachment member 1600 is operable so as to vary the angle of the longitudinal axis of the sidecar with respect to the longitudinal axis of the motorbike 2000. In the embodiment, the longitudinal axis of the sidecar 1000 is defined by the shaft 1310 of chassis 1300. In the embodiment, this is facilitated by selecting a spacer member 1630 with different lengths so as to increase or decrease the distance between the attachment clamp 1640 and the attachment mechanism 1650 as indicated by the arrows in FIG. 6. This has the effect of varying the relative angle between the longitudinal axis of the sidecar 1000 and the longitudinal axis of the motorbike 2000 as shown in the various positions demonstrated FIG. 8. In the embodiment, this varies the relative angle between the chassis 1310 of the sidecar 1000 and the longitudinal axis of the motorbike 2000. This is known in the art as varying the toe-in and toe-out angle.

In alternative embodiments, the toe-in and toe-out angle may be adjusted by varying the relative lateral position of the wheel with respect to the axel upon which it sits. By varying the position of the wheel in this way, variations are able to be achieve with respect to the angle the axis of the longitudinal shaft 1310 makes with the longitudinal axis of the motorbike 2000.

It will be appreciated that other variations are contemplated to varying this distance other than selection of a spacer member 1630 of a required length. For example, spacer member 1630 may be replaced by way of a telescoping sleeve arrangement or the like.

Furthermore, forward vehicle attachment member is operable to vary the attachment location of the first member 1610 on the shaft 1310 as shown by the angels in FIG. 7. This is facilitated in the embodiment by releasably securing the attachment claim 1630 to a selected attachment aperture 1311 from the series of attachment apertures 1311 which extend longitudinally of the shaft. The provision of this variation may be desirable as the toe-in angle is varied and also to provide flexibility to secure the side car to various makes and manufactures of motorbikes 2000.

As before, the ability to vary these relative parameters discussed with reference to FIGS. 6-8, together with the functionality described with refence to earlier figures, advantageously allows the stability, manoeuvrability, and passenger safety characteristics of the sidecar 1000 to be fine tuned to allow for variation to suit individual preferences and different road conditions. It also provides for flexibility in setting up the sidecar 1000 to optimise the stability, manoeuvrability, and passenger safety characteristics of the sidecar 1000 regardless of the make or model of motorbike to which it is secured.

It is contemplated that embodiments within the invention may only provide a subset of these features or a single feature. For example, it is contemplated that a sidecar according to a different embodiment of the invention may only provide for the ability to vary the angle that the wheel 1500 makes with reference to the ground relative to the angle that the motorbike 2000 wheels make with reference to the ground.

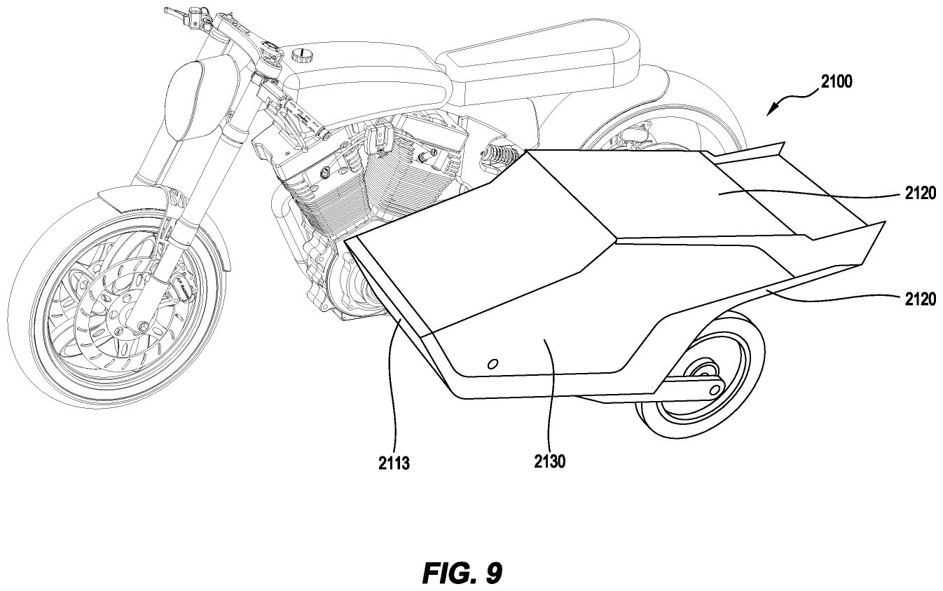

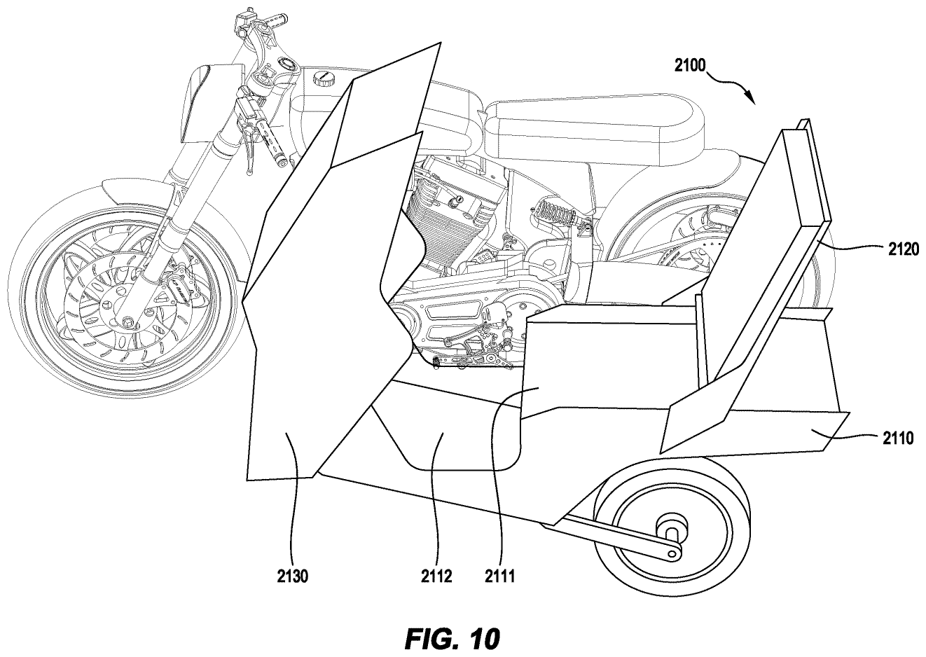

FIGS. 9 and 10 show a further embodiment of a passenger compartment 2100 mounted on frame 1200 (not shown in FIGS. 9 and 10) of sidecar 1000.

Passenger compartment 2100 is suitably securely mounted on frame 1200. The passenger compartment 2100 is moveable between a use configuration as shown in FIG. 10 and a storage configuration as shown in FIG. 9.

Passenger compartment 2100 is formed from a base member 2110 a rear enclosure member 2120 and a forward enclosure member 2130, each moveably mounted to base member 2110.

Base member 2110 is secured on a lower side to frame 1200 as is known in the art. Base member 2110 has a seat portion 2111 configured to seat a rider of the sidecar, a foot portion 2112 configured to support the feet of a ride and front portion 2113.

In the storage configuration, as shown in FIG. 9, both the rear enclosure member 2120 and the forward enclosure member 2130 are rotated with respect to the base member 2110 so as to create an enclosed cavity between the forward enclosure member 2130, the rear enclosure member 2120 and the base member 2110 proximal the foot portion 2112.

This configuration is convenient for use when there is no passenger in the sidecar. The sidecar creates less drag from the air in motion due to the orientation of the enclosure members with respect to the base member. Furthermore, the enclosed cavity provides a weather proof storage space.

In the use configuration, the enclosure members are rotated with respect to the base to permit a passenger to be seated on the base member 2110.

The passenger side car 2100 according to this embodiment of the invention is suitable for being secured to any form of sidecar.

Throughout the specification the aim has been to describe the invention without limiting the invention to any one embodiment or specific collection of features. Persons skilled in the relevant art may realize variations from the specific embodiments that will nonetheless fall within the scope of the invention. For example, individual features from one embodiment may be combined with another embodiment.

It will be appreciated that various other changes and modifications may be made to the embodiment described without departing from the spirit and scope of the invention. For example, a digging tooth may be mounted to the mounting nose instead of an adaptor.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

1. A vehicle sidecar comprising:
a chassis having a sleeve;
a suspension device moveably mounted to the sleeve; and
a locking mechanism disposed between the chassis and the suspension device;
wherein the locking mechanism is moveable between a release position, whereby the suspension device is adapted to move relative to the sleeve, and a locked position to prevent movement of the suspension device relative to the sleeve.

2. The vehicle sidecar of claim 1, wherein the suspension device is adapted to move longitudinally of the sleeve when the locking mechanism is in a release position.

3. The vehicle sidecar of claim 1, wherein the suspension device is adapted to move rotationally of the sleeve when the locking device is in the release position.

4. The vehicle sidecar of claim 1, wherein the chassis further comprises a longitudinal shaft and the sleeve is adapted to be movably mounted on longitudinal shaft when the vehicle sidecar is in use.

5. The vehicle sidecar of claim 4, wherein the sleeve is adapted to be rotatbly mounted on the longitudinal shaft when the vehicle sidecar is in use.

6. The vehicle sidecar of claim 4, wherein the sleeve is adapted to be moveably mounted on chassis so as to permit longitudinal movement of the sleeve with respect to the longitudinal shaft when the vehicle sidecar is in use.

7. The vehicle sidecar of claim 1, wherein the locking mechanism is disposed between the sleeve of the chassis and the suspension device.

8. The vehicle sidecar of claim 7, wherein the locking mechanism provides frictional engagement on an outer face of the sleeve of the chassis and the inner face of a sleeve attachment member of the suspension device when the locking mechanism is in the locked position to thereby prevent relative movement of the sleeve of the chassis with respect to the sleeve attachment member of the suspension device.

9. The vehicle sidecar of claim 1, wherein the suspension device has a wheel rotatbly mounted thereto.

10. The vehicle sidecar of claim 1, wherein a wheel is rotatably secured to the sleeve attachment device.

11. The vehicle sidecar of claim 1, further comprising a forward vehicle attachment device selectively secured to a forward end of the chassis and extending to, and releasably secured to, a vehicle.

12. The vehicle sidecar of claim 1, further comprising a rear vehicle attachment device secured to a rear end of the chassis and extending to, and releasably secured to, a vehicle.
